(19) United States
(12) Patent Application Publication
(10) Pub. No.: US 2010/0066293 A1
(43) Pub. Date: Mar. 18, 2010

(54) VEHICLE-USE START CONTROL SYSTEM

(75) Inventors: Yasuhiko Iriguchi, Anjo-shi (JP); Yuuichi Takamatsu, Anjo-shi (JP)

Correspondence Address: NIXON & VANDERHYE, PC, 901 NORTH GLEBE ROAD, 11TH FLOOR, ARLINGTON, VA, 22203, US

(73) Assignee: DENSO COPORATION, Kariya-city (JP)

(21) Appl. No.: 12/557,794

(22) Filed: Sep. 11, 2009

(30) Foreign Application Priority Data
Sep. 12, 2008 (JP) 2008-235402

(51) Int. Cl. H02P 1/04

(52) U.S. Cl. 318/478

(57) ABSTRACT

The vehicle-use start control system includes a control section which initializes a control signal outputted from the control section when a power supply voltage supplied is lower than or equal to a predetermined initialization voltage, and sets a voltage level of the control signal depending on the detected shift range of the automatic transmission, and a latch section which outputs a start permission/inhibition signal a voltage level of which is indicative of starting of an engine of the vehicle being permitted or inhibited. The latch section latches the voltage level of the start permission/inhibition signal when the power supply voltage is predicted to be lower than or equal to the initialization voltage during the start processing period.

### CROSS-REFERENCE TO RELATED APPLICATION

This application is related to Japanese Patent Application No. 2008-235402 filed on Sep. 12, 2008, the contents of which are hereby incorporated by reference.

### BACKGROUND OF THE INVENTION

1. Field of the Invention

The present invention relates to a vehicle-use start control system which controls starting of a vehicle engine depending on a selected shift range of an automatic transmission.

2. Description of Related Art

Generally, a vehicle having an automatic transmission is provided with a start control system which permits or inhibits crank-starting a vehicle engine depending on a shift range of the automatic transmission. For example, the start control system disclosed in Japanese Patent Application Laid-open No. 2002-118959 is configured to permit supply of electric power to a starter motor for cranking an engine mounted on a vehicle by closing an inhibitor switch when an automatic transmission is in a non-running range, while on the other hand, inhibit supply of electric power to the starter motor by opening the inhibitor switch when the automatic transmission is in a running range in order to prevent a sudden start of the vehicle.

It has been common that an inhibitor switch used in such a start control system is a mechanical contact type switch. However, recently, it is proposed to uses an electric switching circuit to permit or inhibit supply of electric power to a starter motor in accordance with a sensor signal indicative of a shift range of an automatic transmission, as disclosed in Japanese Patent Application Laid-open No. 2007-2812.

In more detail, this system includes a CPU which makes a determination on permission or inhibition of starting of the engine on the basis of the shift range, etc., and is configured to output a voltage signal at the high level or low level depending on a result of the determination to the switching circuit to permit or inhibit supply of electric power to the starter motor. In addition, this system includes a latch circuit connected to the output side of the CPU in order to prevent the output signal of the CPU from being initialized causing supply of electric poser to the starter motor to be interrupted, when a power supply voltage powering the CPU is lowered by performing the cranking operation of the engine when the automatic transmission is in a non-running range. Even if the output signal from the CPU to the latch circuit is initialized due to the lowering of the power supply voltage while the engine is being started, since the output signal is held unchanged in the latch circuit, the power supply voltage can be continuously fed to the starter motor. Incidentally, the power supply voltage is recovered by charging operation of a vehicle alternator when it falls below a certain value.

However, if the power supply voltage repeats lowering and recovering too frequently, the voltage level of the output signal of the CPU becomes unstable. In this case, since the latch circuit of the system disclosed in Japanese Patent Application Laid-open No. 2007-2812 is constituted of just an RS flip-flop, there may occur that the voltage level of an output signal of the latch circuit becomes unstable, causing supply of electric power to the starter motor to be interrupted and causing it difficult to start the engine.

### SUMMARY OF THE INVENTION

The present invention provides a vehicle-use start control system comprising:

a range sensor for detecting a shift range of an automatic transmission of a vehicle;

a control section which initializes a control signal outputted from the control section when a power supply voltage supplied is lower than or equal to a predetermined initialization voltage, and sets a voltage level of the control signal depending on the shift range detected by the range sensor;

a latch section which outputs a start permission/inhibition signal a voltage level of which is indicative of starting of an engine of the vehicle being permitted or inhibited, the latch section being configured to latch the voltage level of the permission/inhibition signal in accordance with the voltage level of the control signal; and

a start permission/inhibition section which permits or inhibits supply of the power supply voltage to a starter motor for crank-starting the engine during a start processing period to start the engine in accordance with the start permission/inhibition signal;

wherein the latch section includes an RS flip-flop which is inputted with a reset signal and a set signal generated from the control signal to latch the voltage level of the start permission/inhibition signal, and a voltage fixing circuit which fixes the voltage level of the reset signal when the power supply voltage is predicted to be lower than or equal to the initialization voltage during the start processing period in order to forcibly cause the RS flip-flop to latch the voltage level of the start permission/inhibition signal.

According to the present invention, there is provided a vehicle-use start control system which affords both excellent startability of a vehicle engine and safety of a vehicle.

Other advantages and features of the invention will become apparent from the following description including the drawings and claims.

### BRIEF DESCRIPTION OF THE DRAWINGS

In the accompanying drawings:

FIG. 1 is a diagram schematically showing the structure of a vehicle-use start control system according to a first embodiment of the invention;

FIG. 2 is a diagram for explaining the operation of the vehicle-use start control system shown in FIG. 1;

FIG. 3 is a block diagram showing the detailed structure of the vehicle-use start control system shown in FIG. 1;

FIG. 4 is a diagram for explaining the operation of a main control section included in the vehicle-use start control system shown in FIG. 3;

FIG. 5 is a diagram for explaining the structure of a latch section included in the vehicle-use start control system shown in FIG. 3;

FIG. 6 is a diagram for explaining the operation of the latch section shown in FIG. 5;

FIG. 7 is a diagram for explaining the structure of a latch section included in a vehicle-use start control system according to a second embodiment of the invention;

FIG. 8 is a diagram for explaining the operation of the vehicle-use start control system according to the second embodiment of the invention; and

FIG. 9 is a block diagram showing the structure of a modification of the vehicle-use start control system according to the first embodiment of the invention.

### PREFERRED EMBODIMENTS OF THE INVENTION

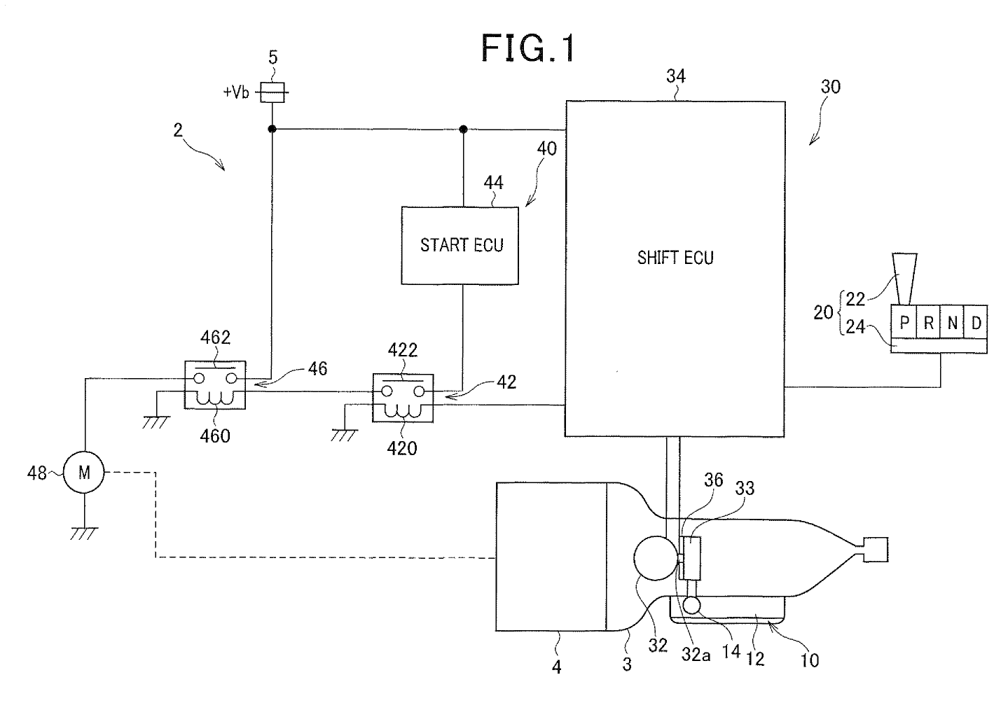

FIG. 1 is a diagram schematically showing the structure of a vehicle-use start control system 2 according to a first embodiment of the invention. The start control system 2 is mounted on a vehicle together with an automatic transmission 3 and an internal combustion engine 4.

The start control system 2 includes an automatic transmission control device 10, a range selector 20, a shift control device 30 and a start control device 40.

The transmission control device 10 includes a hydraulic circuit 12 for driving the automatic transmission 3. The hydraulic circuit 12 includes a manual valve constituted of a spool valve having a spool configured to move linearly. The shift range of the automatic transmission 3 is shifted by the output hydraulic pressure of the hydraulic circuit 12 depending on the position of the spool. The automatic transmission 3 provides a neutral range (N range) and a parking range (P range) as non-running ranges in which the rotational output of the engine 4 is not transmitted to the wheels of the vehicle. The automatic transmission 3 also provides a drive range (D range) and a reverse range (R range) as running ranges in which the rotational output of the engine 4 is transmitted to the wheels of the vehicle.

The range selector 20, which is disposed near the driver's seat of the vehicle, includes a shift lever 22 and a shift sensor 24. The shift lever 22 has four positions corresponding to the P, R, N and D ranges, respectively. The shift sensor 24 detects the current position of the shift lever 22, and generates a signal indicative of the detected position.

The shift control device 30 includes a shift actuator 32, a conversion mechanism 33, a shift electronic control unit (referred to as “shift ECU” hereinafter) 34 and a range sensor 36.

The shift actuator 32 is an electric actuator constituted of an electric motor and a speed reduction mechanism, and configured to generate a rotational output at a rotational shaft 32a thereof when energized. The conversion mechanism 33 converts the rotational output of the shift actuator 32 into linear movement of the spool of the manual valve 14. Hence, the shift range of the automatic transmission 3 is shifted depending on the rotational position of the rotational shaft 32a of the shift actuator 32. Therefore, the shift actuator 32 of this embodiment is provided with the range sensor 36 to detect the current shift range of the automatic transmission 3 corresponding to the rotational position of the rotating shaft 32a. The range sensor 36, which may be a rotary encoder, generates a signal indicative of the current shift range as a detected range Rd.

The shift ECU 34, which is a microcomputer-based electronic control unit, is electrically connected to a vehicle battery 5 to be supplied with a power supply voltage Vb. The shift ECU 34 is also electrically connected to the shift actuator 32, range sensor 36 and shift sensor 24 so that the shift actuator 32 is energized in accordance with the output signals of the range sensor 36 and the shift sensor 24. The shift ECU 34 controls shifting of the automatic transmission 3.

In more detail, when the signal outputted from the shift sensor 24 indicates the P range, the shift ECU 34 controls the shift actuator 32 so that the signal outputted from the range sensor 36 indicates the P range. Likewise, when the signal outputted from the shift sensor 24 indicates the R or N or D range, the shift ECU 34 control the shift actuator 32 so that the signal outputted from the range sensor 36 indicates the R or N or D range. As explained above, in this embodiment, shifting of the shift range is performed by shift-by-wire.

The start control device 40 includes an inhibitor relay 42, a start electronic control unit (referred to as “start ECU” hereinafter) 44, a starter relay 46 and a starter motor 48.

The inhibitor relay 42 is a contact relay including a relay coil 420 and a contact 422. The inhibitor relay 42 is configured to close the contact 422 when the relay coil 420 is energized, and open the contact 422 when the relay coil 420 is deenergized. The relay coil 420 of the inhibitor relay 42 is electrically connected to the shift ECU 34 at one end thereof so that energization and deenergization of the relay coil 422 is controlled by the shift ECU 34.

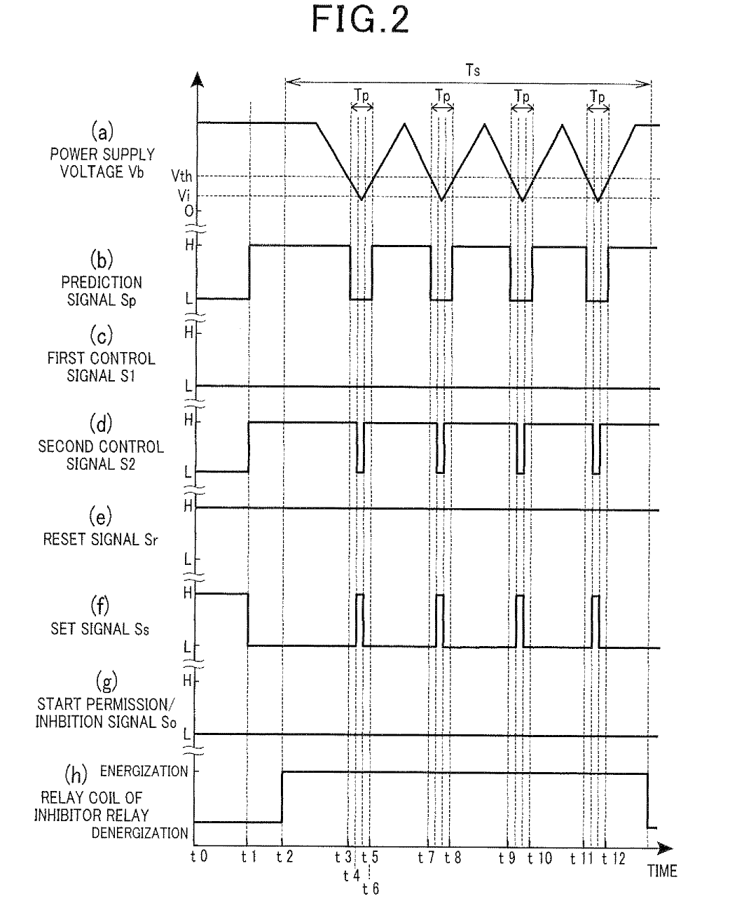

The start ECU 44, which is a microcomputer-based electronic control unit, is electrically connected to the battery 5 to be supplied with the power supply voltage Vb. The start ECU 44 is also electrically connected to the contact 422 of the inhibitor relay 42 to apply the power supply voltage Vb to the contact 422 during a predetermined starting process period Ts which starts in response to an ignition switch on-command etc. (see (a) of FIG. 2). The duration of the starting process period Ts is set to a value necessary to crank the engine 4 until the engine 4 starts complete combustion by closing the contact 422 of the inhibitor relay 42.

The starter relay 46 is a contact relay including a relay coil 460 and a contact 462. The starter relay 46 is configured to close the contact 462 when the relay coil 460 is energized, and open the contact 462 when the relay coil 460 is deenergized. The relay coil 460 of the starter relay 46 is electrically connected to the contact 422 of the inhibitor relay 42 at one end thereof so that the relay coil 460 is energized or deenergized when the contact 422 is closed or opened. The contact 462 of the starter relay 46 is electrically connected to the battery 5 to be applied with the power supply voltage Vb when it is closed.

The starter motor 48, which may be a series-wound direct current cell motor, is electrically connected to the contact 462 of the starter relay 46 when the contact 462 is closed. The starter motor 48 is mechanically connected to the crank shaft (not shown) of the engine 4. The starter motor 48 is driven to crank the engine 4 when the contact 462 of the starter relay 46 is closed to supply the power supply voltage Vb to the starter motor 48. When the contact 462 of the starter relay 46 is opened, the power supply voltage Vb is not supplied to the starter motor 48, and accordingly the starter motor 48 stops.

During the starting process period Ts, when the relay coil 420 is energized through control of the shift ECU 34 to close the contact 422 of the inhibitor relay 42, the relay coil 460 is also energized to close the contact 462 of the starter relay 46. In consequence, supply of the power supply voltage Vb to the starter motor 48 is permitted, and accordingly, starting of the engine 4 is permitted. On the other hand, during the starting process period Ts, when the relay coil 420 is deenergized through control of the shift ECU 34 to open the contact 422 of the inhibitor relay 42, the relay coil 460 is also deenergized to open the contact 462 of the starter relay 46. In consequence, the supply of the power supply voltage Vb to the starter motor 48 is inhibited, and accordingly, starting of the engine 4 is inhibited.

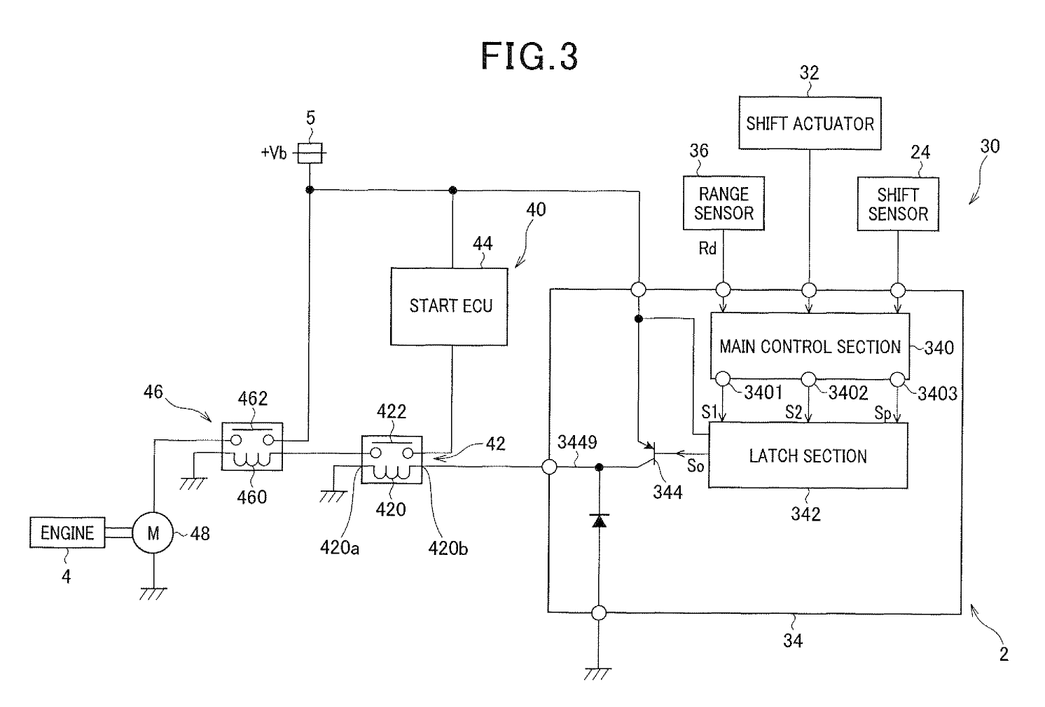

Next, the structure of the vehicle-use start control system 2 is explained. As shown in FIG. 3, the shift ECU 34 includes a main control section 340, a latch section 342 and a switching element 344.

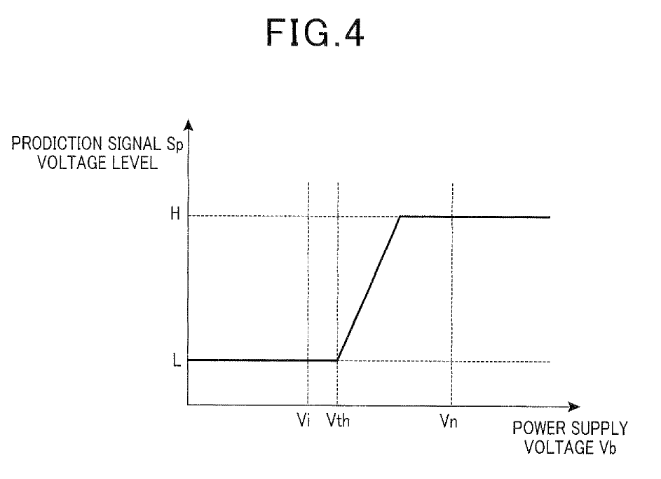

The main control section 340, which is constituted of a microcomputer, is electrically connected to the battery 5 to be supplied with the power supply voltage Vb. The main control section 340 can operate normally when the voltage supplied is higher than or equal to a predetermined normal operation voltage Vn, and is initialized when the voltage supplied is lower than a predetermined initialization voltage Vi (see FIG. 4). The main control section 340 is also electrically connected to the shift actuator 32, range sensor 36 and shift sensor 24 of the shift control device 30 so that it can have a function of generating first and second control signals S1 and S2 having voltage levels depending on the value of the power supply voltage Vb and the detected range Rd by the range sensor 36 in addition to the function of controlling shifting of the shift range in accordance with the detected range Rd.

The main control section 340 sets output terminals 3401 and 3402 from which the first and second control signals S1 and S2 are respectively outputted to a high-impedance state irrespective of the detected range Rd when the power supply voltage Vb falls below or equal to the initialization voltage Vi, to thereby initialize the first and second control signals S1 and S2. On the other hand, when the power supply voltage Vb is above the initialization voltage Vi, the main control section 340 sets the first control signal S1 to the low logic level (referred to as “L level” hereinafter), and sets the second control signal S2 to the high logic level (referred to as “H level” hereinafter) when the detected range Rd is the P range or N range. Even when the power supply voltage Vb is above the initialization voltage Vi, if the detected range Rd is the D range or R range, the main control section 340 sets the first control signal to the H level, and sets the second control signal to the L level.

The main control section 340 outputs a RAM-writing inhibition signal whose voltage level changes depending on the voltage level relation between the power supply voltage Vb and a predetermined threshold voltage Vth higher than the initialization voltage Vi and lower than the normal operation voltage Vn (see FIG. 4). The main control section 340 sets a prediction signal Sp outputted from an output terminal 3403 thereof to the L level when it detects that the power supply voltage Vb is lower than or equal to the threshold voltage Vth, judging that it is presently during a low-voltage prediction period Tp in which the power supply voltage Vb is predicted to be lower than the initialization voltage Vi. On the other hand, the main control section 340 sets the prediction signal Sp to the H level when it detects that the power supply voltage Vb is not lower than the threshold voltage Vth, judging that it is presently out of the low-voltage prediction period Tp, and accordingly, the power supply voltage Vb is not predicted to be lower than the initialization voltage Vi.

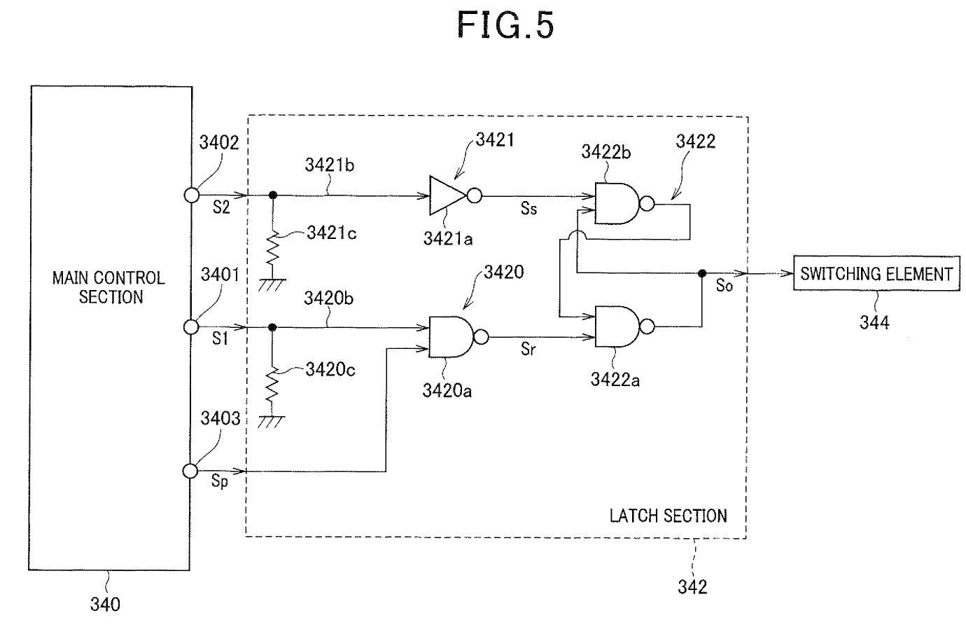

As shown in FIG. 5, the latch section 342 is constituted of a voltage-fixing circuit 3420, a voltage-inverting circuit 3421 and an RS flip-flop 3422.

The voltage fixing circuit 3420 is constituted mainly of a first gate 3420a which is a NAND gate. The input terminals of the first gate 3420a are connected respectively to the output terminal of the output terminals 3401 and 3403 of the main control section 340. A connection line between the first gate 3420a and the output terminal 3401 is grounded through a pull-down resistor 3420c. Accordingly, when the output terminal 3401 is in the high-impedance state, the first control signal S1 initialized to the L level is inputted to the first gate 3420a.

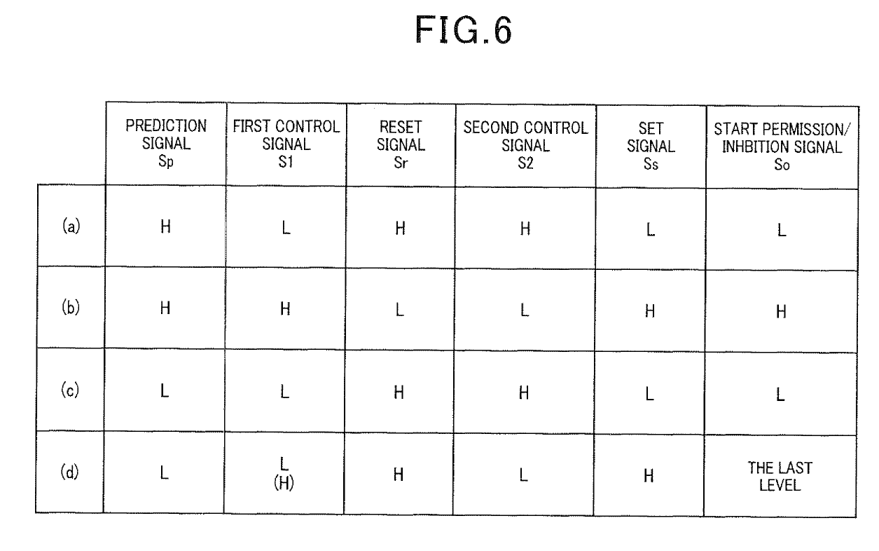

The voltage fixing circuit 3420 having the above explained structure performs a negative AND operation on the first control signal S1 and the prediction signal Sp received from the main control section 340 at the first gate 3420a thereof, the voltage level of a reset signal Sr outputted from the first gate 3420a being set as a result of the negative AND operation. In more detail, as shown in (c) and (d) of FIG. 6, while the prediction signal Sp received is at the L level, the voltage fixing circuit 3420 fixes the reset signal Sr to the H level irrespective of the voltage level of the first control signal S1. On the other hand, as shown in (a) of FIG. 6, when the voltage fixing circuit 3420 is inputted with the first control signal S1 at the L level while the prediction signal Sp received is at the H level, the voltage fixing circuit 3420 inverts the first control signal S1 to output the reset signal Sr at the H level. As shown in (b) of FIG. 6, when the voltage fixing circuit 3420 is inputted with the first control signal S1 at the H level while the prediction signal Sp received is at the H level, the voltage fixing circuit 3420 inverts the first control signal S1 to output the reset signal Sr at the L level.

As shown in FIG. 5, the voltage inverting circuit 3421 is constituted mainly of an inverter 3421a. The input terminal of the inverter 3421a is electrically connected to the output terminal 3402 of the main control section 340. A connection line between the inverter 3421a and the output terminal 3402 is grounded through a pull-down resistor 3421c. Accordingly, when the output terminal 3402 is in the high-impedance state, the second control signal S2 initialized to the L level is inputted to the inverter 3421a.

The voltage inverting circuit 3421 having the above explained structure inverts the second control signal S2 inputted from the main control section 340 at the inverter 3421a thereof, the voltage level of a set signal Ss outputted from the inverter 3421a being set as a result of the voltage level inversion. In more detail, as shown in (c) and (d) of FIG. 6, when the second control signal S2 at the H level is inputted to the voltage inverting circuit 3421, the voltage inverting circuit 3421 outputs the set signal Ss at the L level. On the other hand, as shown in (b) and (d) of FIG. 6, when the second control signal 52 at the L level is inputted to the voltage inverting circuit 3421, the voltage inverting circuit 3421 outputs the set signal Ss at the H level.

As shown in FIG. 5, the RS flop-flop 3422 is constituted of a pair of second gates 3422a and 3422b which are NAND gates cross-connected to each other. The input terminal of the second gate 3422a which serves as a reset input terminal of the RS flip-flop 3422 is electrically connected to the output terminal of the first gate 3420a of the voltage fixing circuit 3420. The input terminal of the second gate 3422b which serves as a set input terminal of the RS flip flop 3422 is electrically connected to the output terminal of the inverter 3421a of the voltage inverting circuit 3421. The output terminal of the second gate 3422a which serves as an output terminal of the RS flip-flop 3422 is electrically connected to the switching element 344.

Each of the second gates 3422a and the 3422b constituting the RS flip-flop 3422 performs a negative NAND operation on one of the set and reset signals and an output of the other of the second gates to generate the start permission/inhibition signal. In more detail, as shown in (a) and (c) of FIG. 6, when the reset signal Sr at the H level and the set signal Ss at the L level are inputted, the RS flip-flop circuit 3422 latches the start permission/inhibition signal S0 to the L level irrespective of its last voltage level. On the other hand, as shown in (b) of FIG. 6, when the reset signal Sr at the L level and the set signal Ss at the H level are inputted, the RS flip-flop circuit 3422 latches the start permission/inhibition signal S0 to the H level irrespective of its last voltage level. Further, as shown in (d) of FIG. 6, when the reset signal Sr at the H level and the set signal Ss at the H level are inputted, the RS flip-flop circuit 3422 latches the start permission/inhibition signal S0 to its last voltage level.

As shown in FIG. 3, the switching element 344, which is a PNP bipolar transistor in this embodiment, is inputted with the start permission/inhibition signal So at its base is electrically connected to the RS flip-flop 3422 of the latch section 342. The emitter of the switching element 344 is electrically connected to the battery 5 to be supplied with the power supply voltage Vb. The collector of the switching element 344 is electrically connected through a connection line 344a to one end 420b of relay coil 420 of the inhibitor relay 42, the other end 420a of which is grounded.

The switching element 344 energizes or deenergizes the relay coil 420 in accordance with the voltage level of the start permission/inhibition signal So received from the latch section 342. In more detail, the switching element 344 energizes the relay coil 420 by applying the power supply voltage Vb to the one end 420b of the relay coil 420 when it is turned on by being inputted with the start permission/inhibition signal So at the L level. On the other hand, the switching element 344 deenergizes the relay coil 420 by bringing the one end 420b of the relay coil 420 to the open state when it is turned off by being inputted with the start permission/inhibition signal So at the H level.

Next, the operation of the vehicle-use start control system 2 is explained. When a start command is given (t0 in FIG. 2), supply of the power supply voltage Vb of the battery 5 higher than the normal operation voltage Vn is started as shown in (a) of FIG. 2. Subsequently, the main control section 340 is initialized before the starting process period Ts starts. After an elapse of a predetermined time after completion of the initialization of the main control section 340 (t1 in FIG. 2), the starting process period Ts starts (t2 in FIG. 2).

When the detected range Rd by the range sensor 36 at the time is the P or N range, the first control signal S1 at the L level shown in (c) of FIG. 2 and the second control signal S2 at the H level shown in (d) of FIG. 2 are inputted from the main control section 340 respectively to the voltage fixing circuit 3420 and the voltage inverting circuit 3421. At the time, since the power supply voltage Vb is higher than the normal operation voltage Vn which is higher than the threshold voltage Vth, the prediction signal Sp at the H level shown in (b) of FIG. 2 is inputted from the main control section 340 to the voltage fixing circuit 3420. As a result, the reset signal Sr at the H level shown in (e) of FIG. 2 and the set signal Ss at the L level shown in (f) of FIG. 2 are inputted respectively from the voltage fixing circuit 3420 and the voltage inverting circuit 3421 to the RS flip-flop 3422. As a consequence, since the start permission/inhibition signal So latched to the L level as shown in (g) of FIG. 2 is inputted from the latch section 342 to the switching element 344, the switching element 344 is turned on to energize the relay coil 420 as shown in (h) of FIG. 2, causing the contact 422 of the inhibitor relay 42 and the contact 462 of the starter relay 46 to be closed in succession. Consequently, the power supply voltage Vb is supplied to the starter motor 48 to start cranking of the engine 4.

Here, the power supply voltage Vb may be lowered during the starting process period Ts due to the cranking of the engine 4 as shown in (a) of FIG. 2. If the power supply voltage Vb falls below or equal to the threshold voltage Vth (time t3 to t6 in FIG. 2), the low-voltage prediction period Tp starts, and the voltage level of the prediction signal Sp inputted from the main control section 340 to the voltage fixing circuit 3420 is changed from the H level to the L level as shown in (b) of FIG. 2.

As a consequence, in a case where the power supply voltage Vb is lowered to a value higher than the initialization voltage Vi and lower than the threshold voltage Vth (t3 to t4 and t5 to t6 in FIG. 2), the first control signal S1 at the L level shown in (c) of FIG. 2 and the second control signal S2 at the H level shown in (d) of FIG. 2 are inputted from the main control section 340 respectively to the voltage fixing circuit 3420 and the voltage inverting circuit 3421. Accordingly, in this case, since the reset signal Sr at the H level shown in (e) of FIG. 2 and the set signal Ss at the L level shown in (f) of FIG. 2 are inputted respectively from the voltage fixing circuit 3420 and the voltage inverting circuit 3421 to the RS flip-flop 3422, the start permission/inhibition signal So is latched to the L level.

In a different case where the power supply voltage Vb is lowered to a value lower than or equal to the threshold voltage Vth (t4 to t5 in FIG. 2), the first and second control signals S1 and S2 respectively inputted to the voltage fixing circuit 3420 and the voltage inverting circuit 3421 are both initialized to the L level as shown in (c) and (d) of FIG. 2. As a result, since the reset signal Sr at the H level shown in (e) of FIG. 2 and the set signal Ss at the H level shown in (f) of FIG. 2 are inputted to the RS flip-flop 3422, the start permission/inhibition signal So is latched to the L-level immediately before the power supply voltage Vb reaches the initialization voltage Vi.

During the low-voltage prediction period Tp, since the voltage fixing circuit 3420 fixes the reset signal Sr to the H level in response to the prediction signal Sp at the L-level in both of these cases, it is possible to forcibly continue the state in which the start permission/inhibition signal So is latched to the L level. Therefore, during the low-voltage predict in period Tp, the start permission/inhibition signal So forcibly latched to the L level is inputted to the switching element 344, and accordingly, the relay coil 420 is kept in the energized state as shown in (h) of FIG. 2. Hence, according to this embodiment, it is possible to maintain the supply of the power supply voltage Vb to the starter motor 48 to ensure excellent startability of the engine 4.

Further, during the starting process period Ts, if the low-voltage prediction period Tp starts repeatedly (t7 to t8, t9 to 10, and t11 to t12 in FIG. 2) due to that the power supply voltage Vb is lowered each time the low-voltage prediction period Tp is completed (t6 in FIG. 2) by the recovery of the power supply voltage Vr, the reset signal Sr is fixed to the H level in each of the repetitions. Accordingly, even if the power supply voltage Vb repeats lowering and recovery, it is possible to ensure excellent startability of the engine 4 by forcibly latching the start permission/inhibition signal So to the L level.

Unlike the above explained cases, when the detected range Rd by the range sensor 36 is the D or R range when the starting process period Ts is started, the first control signal 31 at the H level and the second control signal 32 at the L level are inputted from the main control section 340 respectively to the voltage fixing circuit 3420 and the voltage inverting circuit 3421. At the time, since the power supply voltage Vb is higher than or equal to the normal operation voltage Vn which is higher than the threshold voltage Vth, the prediction signal Sp at the H level is inputted from the main control section 340 to the voltage fixing circuit 3420. As a result, the reset signal Sr at the L level and the set signal Ss at the H level are inputted respectively from the voltage fixing circuit 3420 and the voltage inverting circuit 3421 are inputted to the RS flip-flop 3422. In consequence, since the start permission/inhibition signal So latched to the H level is inputted from the latch section 342 to the switching element 344, the switching element 344 is turned off to denergize the relay coil 420, causing the contact 422 of the inhibitor relay 42 and the contact 462 of the starter relay 46 to be opened in succession. Hence, since the supply of the power supply voltage Vb to the starter motor 48 and accordingly starting of the engine 4 are inhibited during the starting process period Ts, it is possible to prevent a jerky start of the vehicle.

As understood from the above, according to this embodiment, there is provided a vehicle-use start control system which affords both excellent startability of a vehicle engine and safety of a vehicle.

### Second Embodiment

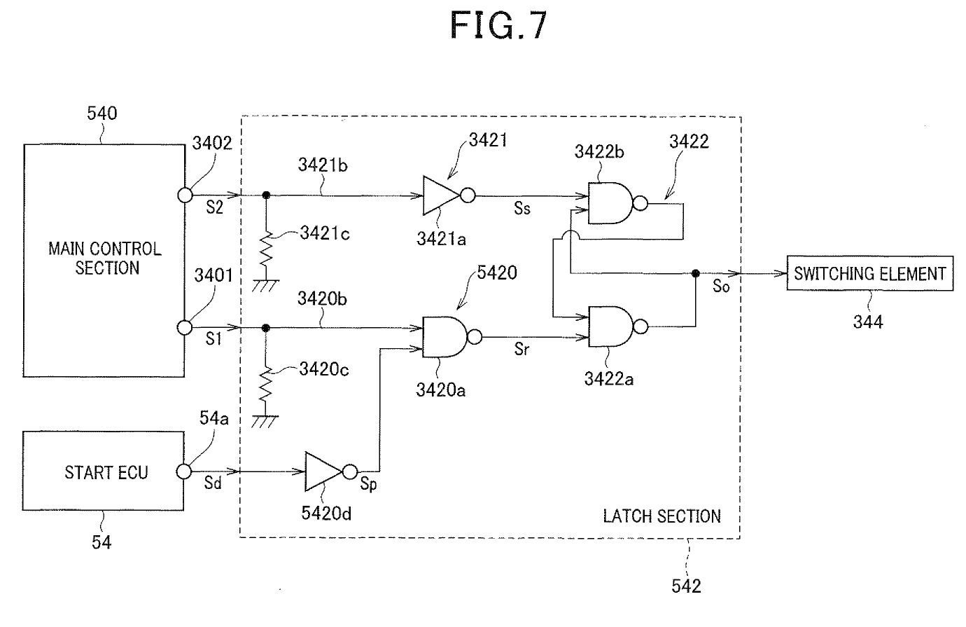

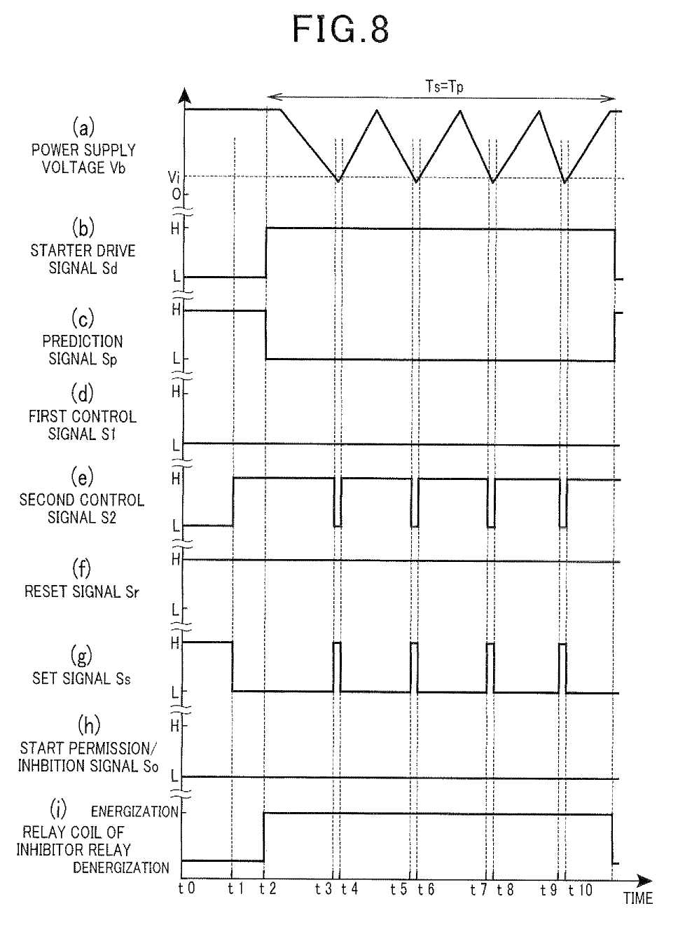

Next, a second embodiment of the invention is described with reference to FIG. 7. Parts that are the same as those shown in previous figures are given the same or similar reference numerals or characters, and are not described again, except as necessary for an understanding of the second embodiment. In the first embodiment, the prediction signal Sp is inputted from the main control section to the voltage fixing circuit of the latch section. On the other hand, in the second embodiment, a starter drive signal Sd is inputted from the starter ECU 54 to the voltage fixing circuit 5420. The starter drive signal Sd is a signal set to the H level when the start ECU 54 sets the whole of the starting process period Ts as the low-voltage prediction period Tp (see FIG. 8). The starter drive signal Sd is set to the L level (see FIG. 8) before the starting process period Ts starts.

The voltage fixing circuit 5420 which receives the starter drive signal Sd in this embodiment includes an inverter 5420d connected between one of the input terminals of the first gate 3420a and an output terminal 54a of the start ECU 54. The voltage fixing circuit 5420 inverts the starter drive signal Sd at the H level inputted from the output terminal 54a of the start ECU 54 by the inverter 5420a thereof, and outputs the resultant signal as the prediction signal Sp at the L level to the first gate 3420a, so that the reset signal Sr is fixed to the H level irrespective of the voltage level of the first control signal S1.

In this embodiment, when the starting process period Ts starts (t2 in FIG. 8) when the detected range Rd is the P or N range, the starter drive signal Sd at the H level as shown in (b) of FIG. 8 is inputted to the inverter 5420d due to setting of the low-voltage prediction period Tp. As a result, the prediction signal Sp at the L level is inputted to the first gate 3420a as shown in (c) of FIG. 8. At the time, since the power supply voltage Vb higher than the normal operation voltage Vn which is higher than the reset voltage Vi is being supplied, the first control signal 31 at the L level shown in (d) of FIG. 8 and the second control signal S2 at the H level shown in (e) of FIG. 8 are inputted respectively to the voltage inverting circuit 5420 and the voltage inverting circuit 3421. As a consequence, the reset signal Sr at the H level shown in (f) of FIG. 8 and the set signal Ss at the H level shown in (g) of FIG. 8 are inputted to the RS flip-flop 3422. At the time, since the reset signal Sr is fixed to the H level by the first gate 3420a, the start permission/inhibition signal So inputted from the latch section 542 to the switching element 344 is forcibly latched to the L level as shown in (h) of FIG. 8. Accordingly, the switching element 344 is turned on to energize the relay coil 420 as shown in (i) of FIG. 8, and the power supply voltage Vb is supplied to the starter motor 48 to start cranking of the engine 4.

During the starting process period Ts in which the cranking is started, if the power supply voltage Vb falls below the reset voltage Vi (t3 to t4, t5 to t6, t7 to t8 and t9 to t10 in FIG. 8), the first and second control signals S1 and S2 respectively inputted to the inverting circuit 5420 and the voltage inverting circuit 3421 are set to the L level as shown in (d) and (e) of FIG. 8. At the time, the first gate 3420a is inputted with the inverted version of the starter drive signal Sd at the H level, that is, the prediction signal at the L level as shown in (b) and (c) of FIG. 8. Accordingly, since the reset signal Sr and the set signal Ss both at the H level shown (f) and (g) of FIG. 8 are inputted to the RS flip-flop 3422, the start permission/inhibition signal So is latched to the L level immediately before the power supply voltage reaches the reset voltage Vi as shown in (h) of FIG. 8. Here, since the reset signal Sr is being fixed to the H level, the start permission/inhibition signal So is forcibly latched to the L level.

Accordingly, since the switching element 344 receives the start permission/inhibition signal So latched to the L level from the latch section 342 during the whole of the starting process period Ts set as the low-voltage prediction period Tp, the relay coil 420 is kept in the energized state as shown in (i) of FIG. 8. Hence, even if lowering and recovery of the power supply voltage Vb is repeated during the starting process period Ts, it is possible to continue the supply of the power supply voltage Vb to the starter moptor 48 to afford excellent engine startability.

Unlike the above explained case, in a case where the detected range Rd is the D or R range during the starting process period Ts, since the power supply voltage Vb higher than the normal operation voltage Vn is being supplied, the first control signal S1 at the H level and the second control signal S2 at the L level are inputted respectively to the voltage inverting circuit 5420 and the voltage inverting circuit 3421. At the time, since the first gate 3420a is inputted with the inverted version of the starter drive signal Sd at the H level, that is, the prediction signal Sp at the L level due to setting of the low-voltage prediction period Tp, the reset signal Sr and the set signal Ss both at the H level are inputted to the RS flip-flop 3422. In consequence, since the start permission/inhibition signal So latched to the H level immediately before the starting process period Ta starts is inputted from the latch section 342 to the switching element 344, the switching element 344 is turned off to denergize the relay coil 420. Hence, since the supply of the power supply voltage Vb to the starter motor 48 and accordingly starting of the engine 4 are inhibited during the starting process period Ts, it is possible to prevent a jerky start of the vehicle. Incidentally, in the second embodiment, the start permission/inhibition signal So is latched to the H level immediately before the starting process period Ta starts, like in the case where the detected range Rd is the D or E range in the first embodiment.

As understood from the above, also according to the second embodiment, there is provided a vehicle-use start control system which affords both excellent startability of a vehicle engine and safety of a vehicle.

It is a matter of course that various modifications can be made to the above described embodiments.

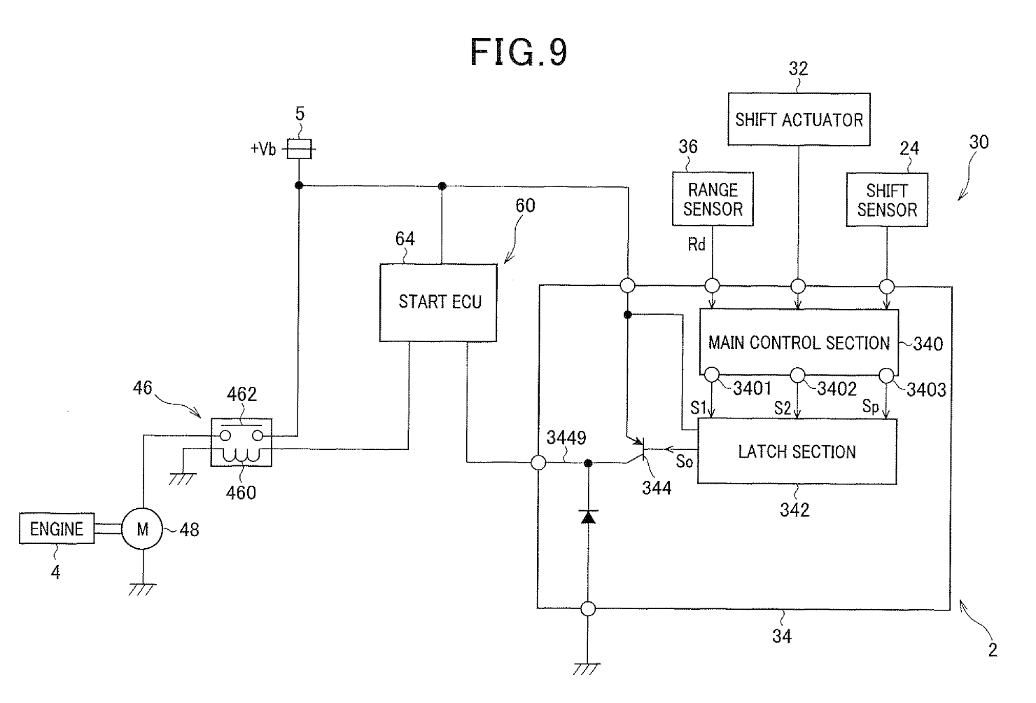

For example, as shown in FIG. 9, instead of providing the start control device 60 with the inhibitor relay 42, the start ECU 64 may be directly connected with the switching element 344 and the relay coil 460 of the starter relay 46 so that energization and deenergization of the relay coil 460 can be controlled by the start ECU 64.

What is claimed is:

1. A vehicle-use start control system comprising:
a range sensor for detecting a shift range of an automatic transmission of a vehicle;
a control section which initializes a control signal outputted from said control section when a power supply voltage supplied is lower than or equal to a predetermined initialization voltage, and sets a voltage level of said control signal depending on said shift range detected by said range sensor;
a latch section which outputs a start permission/inhibition signal a voltage level of which is indicative of starting of an engine of said vehicle being permitted or inhibited, said latch section being configured to latch said voltage level of said permission/inhibition signal in accordance with said voltage level of said control signal; and
a start permission/inhibition section which permits or inhibits supply of said power supply voltage to a starter motor for crank-starting said engine during a start processing period to start said engine in accordance with said start permission/inhibition signal;
wherein said latch section includes an RS flip-flop which is inputted with a reset signal and a set signal generated from said control signal to latch said voltage level of said start permission/inhibition signal, and a voltage fixing circuit which fixes said voltage level of said reset signal when said power supply voltage is predicted to be lower than or equal to said initialization voltage during said start processing period in order to forcibly cause said RS flip-flop to latch said voltage level of said start permission/inhibition signal.

2. The vehicle-use start control system according to claim 1, wherein said power supply voltage is predicted to be lower than or equal to said initialization voltage when said power supply voltage falls below or equal to a predetermined threshold voltage higher than said initialization voltage.

3. The vehicle-use start control system according to claim 1, wherein said power supply voltage is predicted to be lower than or equal to said initialization voltage during whole of said starting process period.

4. The vehicle-use start control system according to claim 1, wherein said control signal is constituted of a first control signal and a second control signal,
said reset and set signals being generated respectively from said first and second control signals,
said control section being configured to set voltage levels of said first and second control signals to opposite levels with respect to each other depending on said detected shift range when said power supply voltage is above said initialization voltage, and initialize said first and said control signals to a predetermined one of said opposite voltage levels when said power supply voltage falls below or equal to said initialization voltage,
said voltage level of said reset signal being fixed by said voltage fixing circuit in order that said voltage level of said start permission/inhibition signal is latched in said RS flip-flop when said power supply voltage is predicted to be lower than or equal to said initialization voltage.

5. The vehicle-use start control system according to claim 4, wherein said control section outputs a prediction signal set to a low voltage level when said power supply voltage is predicted to be lower than or equal to said initialization voltage,
said latch circuit includes a voltage inverting circuit which inverts said second control signal to generate said set signal,
said voltage fixing circuit includes a first gate which performs a negative NAND operation on said first control signal and said prediction signal to generate said reset signal, and
said RS flip-flop is constituted of a pair of second gates which are cross connected to each other, and respectively inputted with said reset signal and said set signal, each of said second gates performing a negative NAND operation on one of said set and reset signals and an output of the other of said second gates to generate said start permission/inhibition signal.

6. The vehicle-use start control system according to claim 5, wherein said prediction signal is set to a high voltage level when said power supply voltage is predicted not to be lower than or equal to said initialization voltage, said first gate performing a negative NAND operation on said first control signal and said prediction signal to generate said reset signal.
